(19) United States
(12) Patent Application Publication
(10) Pub. No.: US 2013/0333396 A1
(43) Pub. Date: Dec. 19, 2013

(54) CRYOGENIC COOLING APPARATUS FOR TRANSPORT OF PERISHABLE GOODS

(71) Applicant: Simon James HANDLEY, Kendal (GB)

(72) Inventor: Simon James HANDLEY, Kendal (GB)

(73) Assignee: Linde Aktiengesellschaft, Munich (DE)

(21) Appl. No.: 13/523,980

(22) Filed: Jun. 15, 2012

(51) Int. Cl. F17C 9/02

(52) U.S. Cl. CPC F17C 9/02
USPC 62/48.1

(57) ABSTRACT

A portable cryogenic cooling apparatus includes a platform; a tank for storing a cryogen and mounted to the platform; a heat exchanger operatively associated with the platform and in fluid communication with the cryogen; at least one air circulation device operatively associated with the heat exchanger for moving atmosphere therethrough; a first exhaust pipe in communication with the heat exchanger for removing gaseous cryogen from the heat exchanger to a location external to the atmosphere; a power source mounted to the platform and connected to the at least one air circulation device for powering said device; a control valve operatively associated with the tank and the heat exchanger to adjust an amount of the cryogen provided to the heat exchanger; and a controller in communication with the heat exchanger and the control valve for generating a signal to the control valve for operation thereof.

### BACKGROUND

The present inventive embodiments relate to apparatus and systems for transporting chilled or frozen products, such as food products, in trucks or other containers.

Known transport systems for products such as food products rely upon diesel to fuel a compressor that circulates a refrigerant for chilling or cooling the products. Refrigerated carriers predominantly use mechanical systems to provide both chill and frozen transport. It is not uncommon that during times of peak flow when there is a high demand for refrigerated transport, truckers or other haulers do not have an adequate supply of suitable vehicles with installed refrigeration systems to transport the products. In addition, many of the known mechanical systems are constructed only to cope with small changes in the environment in which they operate or limited to operational designs when initially installed and adjusted with a particular container in which they are employed. During higher than normal ambient temperatures or when the temperature set point is reduced to a much lower level, or an increase in product is needed to be cooled, mechanical systems are usually unable to keep up with the demands for cooling that are required.

Moreover, existing trucks, containers or other transport systems may only on occasion be required to transport chilled or frozen products for a short period of time. It may therefore not be cost efficient to have the container portion of the truck to be constructed with permanent fixtures for cooling and insulating the compartment.

### SUMMARY OF THE INVENTION

The present inventive embodiments provide a portable apparatus which is retrofitable to non-insulated or existing insulated vehicles or containers to convert a non-refrigerated space into a chilled or frozen space for transport of sensitive or perishable goods. The present apparatus permits the hauler, on short notice, to provide a refrigerated transport that will meet the customer's requirements and, where necessary, be able to increase the cooling efficiency of the container and alter a chilled transport container to a frozen transport container. The present apparatus also enables the hauler to convert a non-insulated van into a chilled transport apparatus by removably installing the present cooling apparatus and as necessary installing removably mountable insulation material at a side wall of the transport container.

A portable cryogenic cooling apparatus is provided which includes a movable platform; a tank for storing a cryogen therein and being mounted to the platform; a heat exchanger operatively associated with the platform and in fluid communication with the cryogen stored in the tank; at least one air circulation device operatively associated with the heat exchanger for moving atmosphere through the heat exchanger; an exhaust pipe in communication with the heat exchanger for removing gaseous cryogen from the heat exchanger to a location remote from the atmosphere; a power source mounted to the platform and connected to the at least one air circulation device for powering said device; a control valve operatively associated with the tank and the heat exchanger to adjust an amount of the cryogen provided to the heat exchanger; and a controller in communication with the heat exchanger and the control valve for generating a signal to the control valve for operation thereof.

### BRIEF DESCRIPTION OF THE DRAWINGS

For a more complete understanding of the present inventive embodiments, reference may be had to the following drawing Figures taken in conjunction with the description of the embodiments, of which:

FIG. 1 shows a schematic of a portable cryogenic cooling apparatus according to the present embodiments;

FIG. 2 shows a schematic of an end view of the apparatus shown in FIG. 1;

FIG. 3 shows a schematic of a pipe and instrument diagram for the embodiment of FIG. 1;

FIG. 4 shows a schematic of another embodiment of a portable cryogenic cooling apparatus; and

FIG. 5 shows the cryogenic cooling apparatus embodiment of either of FIGS. 1 and 4 being removably positioned for use in a transport container.

### DETAILED DESCRIPTION OF THE INVENTION

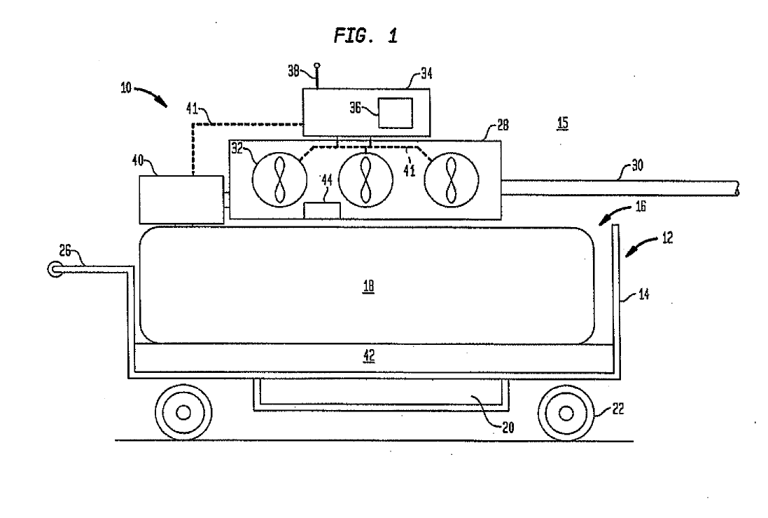

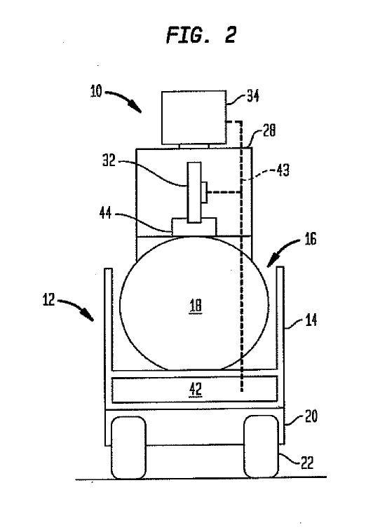

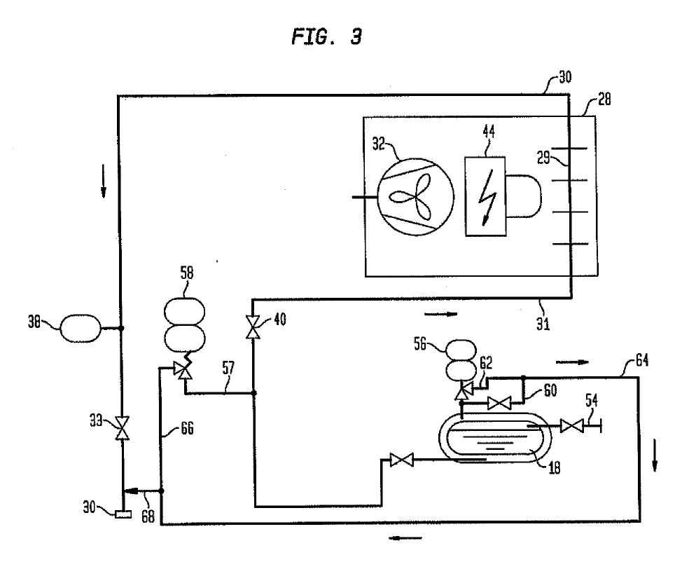

Referring to FIGS. 1-3, a portable cryogenic cooling apparatus is shown generally at 10. A schematic of a pipe and instrument diagram is shown in FIG. 3 for the embodiment shown in FIGS. 1 and 2.

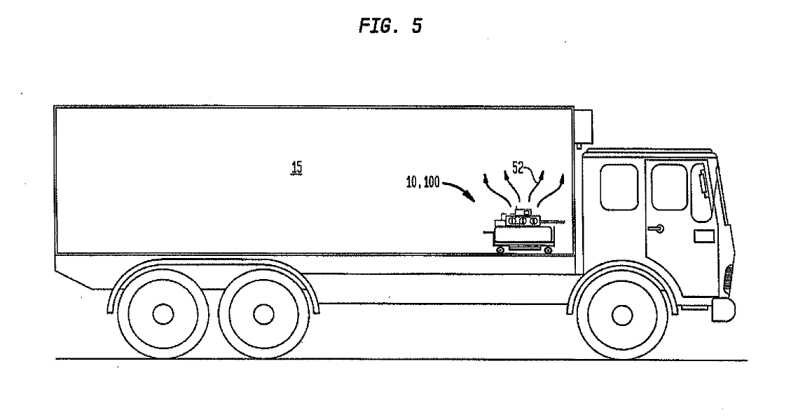

The apparatus 10 includes a dolly 12 or similar type of wheeled platform having a plurality of sidewalls 14 arranged to provide an open ended side 16 in which a liquid cryogen tank 18 or vessel can be disposed. Liquid nitrogen (LIN), liquid carbon dioxide (CO₂) or liquid hydrogen can be stored in the tank 18. By way of example only, LIN will be referenced herein, but other cryogens such as for example liquid CO₂ can be used as well. The tank 18 may be removably mounted to the dolly 12. A forklift bracket 20 or stanchion is provided at an underside of the dolly 12 so that forklift arms (not shown) or tongs can be releasably engaged to the forklift brace to deposit the apparatus 10 in a compartment space 15, truck or other container, and remove the apparatus from same. Upon placement of the apparatus 10 in the truck or container, such as shown in FIG. 5, the dolly 12 can be moved upon wheels 22 or casters to a select position in the truck. A handle 26 extends from one of the sidewalls 14 to maneuver the dolly 12.

A heat exchanger 28 is mounted to the dolly such as for example above the tank 18. The heat exchanger has one end of its coil 29 in communication with a pipe 31 to the LIN in the tank 18, while an opposite end of the coil extends to be in communication with an exhaust pipe 30 from the heat exchanger. The exhaust pipe 30 may be manufactured from a flexible material for example. At least one fan 32 is operatively associated with the heat exchanger 28 to draw the atmosphere in the space 15 across the heat exchanger coil for reducing the temperature of the space.

A process logic controller (PLC) 34 includes a human machine interface (HMI) 36 therein and a temperature control sensor 38. A control valve 40 controls the amount of liquid nitrogen that is removed from the tank 18 to the coil of the heat exchanger 28. The PLC 34 interconnects the fans 32, the temperature sensor 38 and the control valve 40, as shown by broken lines 41, to adjust the amount of nitrogen necessary to be removed from the tank 18 through the coil 29 of the heat exchanger 28 to meet the demands to reduce the temperature of the compartment space 15.

The tank 30 can, be way of example only, have a capacity of 200 liters (approximately 53 gallons). The exhaust pipe 30 can be manufactured from a flexible hose to vent nitrogen gas from the heat exchanger 28 to an area external from the compartment space 15. An alarm (not shown) will signal a driver or user of the apparatus 10, or for that matter anyone in the compartment space 15, should for some reason nitrogen gas enter the compartment space and displace the breathable oxygen to a level insufficient to support life.

The tank 18 can be filled either from a small liquid nitrogen delivery vehicle (not shown), or the user or customer of the apparatus 10 can use a small (perhaps on-site) cryogenic vessel having volume of for example 3,000 liters (approximately 793 gallons), mounted on a skid to top-up the tank. A pipe 54 is provided to introduce the liquid cryogen from the remote source (not shown) into the tank 18.

A battery pack 42 is self-contained and connected to the fans 32 and the controller 34, as shown by broken lines 43 to provide power for the fans and the controller. The pack 42 may be removable mounted to the dolly 12. The battery pack 42 may be of the rechargeable type or alternatively, the battery pack or the apparatus 10 may be connected directly to the vehicle electronics or work off a main power supply through an auxiliary socket (not shown).

The total weight of the apparatus 10 may be for example approximately 150 kilograms (approximately 331 pounds), with the system manufactured from stainless steel and composite material such as carbon fiber. The apparatus 10 is a closed, indirect system for providing chilling or freezing to the products (not shown) in the compartment space 15. That is, none of the liquid or gaseous nitrogen contacts the products, as said nitrogen gas is vented or exhausted external to the compartment space 15. The tank 18 can be insulated with for example vacuum jacketing.

The heat exchanger 28 may also include a heater 44 which, during maintenance, can be used to melt and remove condensate that has frozen to the coils of the heat exchanger. Since the heater 44, shown for example in FIG. 3, will draw too much power to run continuously, the heater is run only when condensate accumulating on the coil of heat exchanger 28 renders the heat exchanger inoperative or inefficient, or when the apparatus 10 is removed from the compartment space 15.

In order to fill the tank 18 with the liquid cryogen, air or other gas must be displaced or removed from within the tank. Therefore, an exhaust line 60 or pipe having a valve therein is in communication with an interior of the tank 18 as shown in FIG. 3 to remove displaced air in the tank therefrom. Another line 62 or pipe is in communication with the line 60 which is connected to a pressure relief valve 56 which will open when the pressure of air or gas within the tank 18 reaches a certain limit. The lines 60,62 are connected to a line 64 or pipe which extends to and is in communication with a further line 68 or pipe to exhaust the cryogenic gas from the compartment space 15.

Another line 57 or pipe branches off from the pipe 31, and such line 37 has a pressure relief valve 58. A line 66 or pipe extends from the pressure relief valve 58 and is in communication with the line 68 so that gas from the line 31 can ultimately also be exhausted from the compartment space 15 as shown in FIG. 3. The line 68 is in communication with the exhaust pipe 30 downstream of a valve 33, which valve is disposed in the exhaust pipe 30 for exhausting the cryogenic gas from the heat exchanger 28.

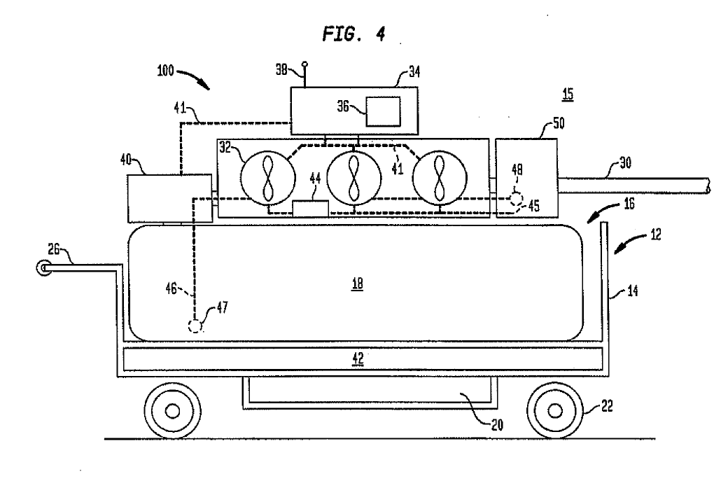

Referring to FIG. 4, another embodiment of the portable cryogenic cooling apparatus is shown generally at 100. The apparatus 100 includes the elements described above with respect to the embodiment of FIGS. 1 and 2, and also includes a hydrogen fuel cell 50 which is connected to the fans 32, as shown by the broken lines 45, to power same. Hydrogen gas for the fuel cell 50 is provided from the liquid hydrogen in the tank 18. A pipe 46 or conduit has one end 47 in fluid communication with the tank 18, and an opposite end 48 in fluid communication with the fuel cell 50. The fuel cell 50 reduces the load on the battery pack 42.

In FIG. 5, either one or both of the portable cryogenic cooling apparatus 10,100 can be moved or positioned by being rolled into a container or housing mounted to a truck. The container or housing may be movably mounted to the truck. In this manner of construction, a container may be removed from the truck, with the apparatus 10,100 disposed therein, and loaded aboard a ship or barge for transport to a remote location, or stored as is aboard the ship or barge. When the apparatus 10,100 is disposed within the container at the select position, wheel locks (not shown) on the dolly 12 are actuated and/or the apparatus is lashed with known gear to an underlying surface to prevent movement of the apparatus within the container.

The portable cryogenic cooling apparatus embodiment 10,100 described herein can be removably disposed within a shipping or truck, container upon very short notice. The apparatus is closed, i.e. a closed, indirect cryogen system such that none of the cryogen, such as liquid nitrogen or carbon dioxide, contacts the product, such as food products that are being chilled or frozen, or electronic equipment that is cooled, by airflow 52. The apparatus 10,100 can be lifted into the container or on to the vehicle by a forklift and then further wheeled into the container to a select position. Exhaust from the apparatus 10,100 is vented through the vehicle's rear door or through a port or hole provided in a side wall of the container.

The apparatus 10,100 can be used in work spaces where cooling is required for personnel or computer equipment. The apparatus can also be used where temporary cooling or chilling is required for other sensitive equipment. The cryogen used with the apparatus can be liquid hydrogen. Hydrogen gas can be used with the embodiment of FIG. 4 to provide the necessary gas for the hydrogen fuel cell 50 to power the battery pack 42 for the fans 32 of the heat exchanger 28.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A portable cryogenic cooling apparatus, comprising:
a platform;
a tank for storing a cryogen therein and being mounted to the platform;
a heat exchanger operatively associated with the platform and in fluid communication with the cryogen stored in the tank;
at least one air circulation device operatively associated with the heat exchanger for moving atmosphere through the heat exchanger;
a first exhaust pipe in communication with the heat exchanger for removing gaseous cryogen from the heat exchanger to a location external to the atmosphere;
a power source mounted to the platform and connected to the at least one air circulation device for powering said device;
a control valve operatively associated with the tank and the heat exchanger to adjust an amount of the cryogen provided to the heat exchanger; and
a controller in communication with the heat exchanger and the control valve for generating a signal to the control valve for operation thereof.

2. The apparatus of claim 1, wherein the cryogen is selected from a group consisting of liquid nitrogen, liquid carbon dioxide and liquid hydrogen.

3. The apparatus of claim 1, wherein the power source comprises a battery, the battery being removably mounted to the platform.

4. The apparatus of claim 1, further comprising a temperature sensor in communication with the controller for generating a signal responsive to a temperature of the atmosphere.

5. The apparatus of claim 1, further comprising a forklift bracket mounted to the platform for releasably engaging forklift arms for movement of the platform.

6. The apparatus of claim 1, further comprising wheels mounted to an underside of the platform for permitting rolling movement of said platform.

7. The apparatus of claim 1, further comprising a handle connected to the platform for maneuvering the platform.

8. The apparatus of claim 1, wherein the platform comprises a sidewall defining an open ended containment space in which the tank is received.

9. The apparatus of claim 1, wherein the tank is removably mounted to the platform.

10. The apparatus of claim 1, wherein the first exhaust pipe is formed of flexible material.

11. The apparatus of claim 1, further comprising a hydrogen fuel cell connected to the power source for providing power to said power source.

12. The apparatus of claim 1, further comprising a heater operatively associated with the heat exchanger for melting frozen condensate disposed upon coils of said heat exchanger.

13. The apparatus of claim 1, further comprising a pressure relief valve operatively associated with the first exhaust pipe.

14. The apparatus of claim 1, further comprising second exhaust pipe in communication with the tank through which gas in the tank is exhausted to the location external to the atmosphere.

15. The apparatus of claim 14, further comprising a pressure relief valve operatively associated with the second exhaust pipe.
